(19) United States
(12) Patent Application Publication
(10) Pub. No.: US 2010/0045165 A1
(43) Pub. Date: Feb. 25, 2010

(54) FLUORESCENT LAMP

(76) Inventors: Katsuyuki Nagahama, Osaka (JP); Shiro Iida, Kyoto (JP); Noriyuki Uchida, Osaka (JP); Hiromi Tanaka, Osaka (JP); Masahiro Miki, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/541,395

(22) Filed: Aug. 14, 2009

(30) Foreign Application Priority Data
Aug. 19, 2008 (JP) 2008-210714

(51) Int. Cl. H01J 63/04; H01J 9/00

(52) U.S. Cl. 313/493; 445/26

(57) ABSTRACT

Provided is a fluorescent lamp composed of a bulb and bases provided at base ends. The bulb includes (a) a circumferential wall whose inner surface is coated with a fluorescent layer and (b) end walls each partially composed of a stem to which an electrode is attached, the stem being plate-shaped. The bases are each provided covering a corresponding one of the stems such that at least part of each end wall other than the stem is exposed. An inner surface of each stem is positioned closer to a center of the bulb in a bulb axis direction than an imaginary plane containing a corresponding edge of the bulb is.

This application is based on application No. 2008-210714 filed in Japan, the contents of which are hereby incorporated by reference.

### BACKGROUND OF THE INVENTION

(1) Field of the Invention

The present invention relates to a fluorescent lamp, a lighting apparatus, and a manufacturing method of the fluorescent lamp.

(2) Description of the Related Art

Conventional fluorescent lamps (hereinafter, referred to simply as “lamps”) include a tubular bulb provided with, at each end portion thereof, a base that is electrically connected with an electrode. In such lamps, base pins that are electrically connected with the electrodes extend outwardly from the end portions of the bulb in the direction in which the tube axis of the bulb extends (hereinafter, also referred to as “tube axis direction”). Accordingly, in a lighting apparatus having such lamps attached thereto, if the lamps are, for example, in a shape of a straight tube, the lamps always have sockets of the lighting apparatus on their sides.

In addition, since flare stems have a thin tube, thicker bases are necessary at the end portions of the lamp to cover the thin tube as well. When the above-mentioned straight-tube lamps are, for example, arranged in series in their longitudinal direction (so-called “line illumination”), bases and sockets for the bases are sandwiched between each two adjacent lamps. This increases a gap between each two adjacent lamps and consequently enlarges a dark part (non-light emitting part) between these lamps.

The following is one known method to diminish dark parts when realizing such line illumination (for example, see Japanese Utility Model Application Publication S61-48548, Japanese Patent No. 3149077, and Japanese Patent Application Publication No. 2004-247276). Bases or base pins are provided in the direction perpendicular to the lamp axis to eliminate bases or sockets located between adjacent lamps, thereby diminishing a gap between the adjacent lamps and enabling the lamps to illuminate as if the lamps were one lamp.

In response to such a need, a certain type of lamps have been studied. This type of lamps have the following structure: plate-shaped stem mounts, instead of flare-shaped ones, are used for holding electrodes; and stems of these stem mounts are welded so as to cover openings positioned substantially at the center of the end walls of the glass tube which constitutes the bulb.

FIG. 1 is a schematic longitudinal sectional view of a structure of an end portion of a lamp under study.

In a lamp 901 as shown in FIG. 1, a base 915 is provided at an end portion 905 of a bulb 903 to cover a stem 913 located at the center of an end surface 911, such that an end wall 909 coated with a fluorescent 907 is exposed (the end wall 909 corresponds to, for example, a portion indicated by a reference numeral 12 in FIG. 4).

This structure enables not only light emitted through a tubular portion 917, which is the main part of the bulb 903, but also light emitted through the end wall 909 to be utilized for illumination, thereby improving the luminance of the entire lamp as well as that of the lamp end portion 905. In addition, in the lamp having the stem 913 at the end surface 911, the thickness of the base 915 can be reduced, and accordingly, dark parts formed between adjacent lamps 901 used in realization of line illumination are also reduced.

The base 915 is composed of a first part 919 and a second part 921. The first part 919 covers the stem 913 of the end surface 911, and the second part 921 is provided along the outer circumference of the end portion 905 of the bulb 903 and includes base pins 923 vertically arranged extending in the direction perpendicular to the lamp axis.

The first part 919 of the base 915 is prepared in a size that blocks as little light from the end wall 909 as possible. The base 915 is L-shaped as a whole, and is fixed to the end portion 905 of the bulb 903 by a bonding agent. Note that although the interior of the base 905 is filled with the bonding agent, an illustration is omitted to give a clear view of wiring of the leads and the like in FIG. 1.

Changing the shape of the stem mounts from flare-shaped to plate-shaped allowed for thinner bases and narrower gaps between two adjacent lamps. However, the end surface 911 of the bulb 903 still protrudes by the thickness of the stem 913 (“L1” in the figure). Due to this protrusion of the thickness L1, the portion of the base 915 that covers the stem 913 protrudes further by as much (“L2” in the figure).

### SUMMARY OF THE INVENTION

The present invention aims to provide a fluorescent lamp, a lighting apparatus using the fluorescent lamp, and a manufacturing method of the fluorescent lamp able to reduce the protrusion amount of the bases provided at the end portions of the bulb.

In order to achieve the stated aim, the fluorescent lamp pertaining to the present invention is a fluorescent lamp, comprising: a bulb including (a) a circumferential wall whose inner surface is coated with a fluorescent layer and (b) end walls each partially composed of a stem to which an electrode is attached, the stem being plate-shaped; and bases each provided covering a corresponding one of the stems such that at least part of each end wall other than the stem is exposed, wherein an inner surface of each stem is positioned closer to a center of the bulb in a bulb axis direction than an imaginary plane containing a corresponding edge of the bulb is.

Note that “an edge of the bulb” is the outermost contour line of an end surface of the bulb when the end surface of the bulb is viewed in the bulb axis direction, and in a case where “an edge of the bulb” is not straight when the bulb is viewed in the direction perpendicular to the bulb axis direction (that is, when “an edge of the bulb” is uneven in the bulb axis direction), a straight line obtained by averaging its uneven portions is “an edge of the bulb”.

The fluorescent lamp with the stated structure can reduce the outward protrusion amount of the bases from the imaginary planes respectively containing edges of the bulb. As a result, for example, when used in line illumination, the fluorescent lamps can be arranged with narrower gaps therebetween. Also, when the fluorescent lamps are arranged in series in their longitudinal direction, dark parts between the fluorescent lamps can be diminished.

In the above-describe fluorescent lamp, an outer surface of each stem may be positioned closer to the center of the bulb than the imaginary plane is, and each end wall other than the stem extends from the corresponding edge of the bulb toward an edge of the stem.

An outer surface of each stem may be substantially flush with the imaginary plane.

Each stem may be disk-shaped and block an opening provided at a center of the end wall, and an outer diameter of the stem is in a range of 1.2 times to 1.5 times an outer diameter of the opening.

A thickness of each stem may be in a range of 0.8 times to 3 times a thickness of each end wall.

Also, in order to achieve the stated aim, the lighting apparatus pertaining to the present invention is a lighting apparatus, comprising: an apparatus main body; and one or more fluorescent lamps attached to the apparatus main body, wherein each of the fluorescent lamps is the fluorescent lamp of Claim 1.

According to the stated structure, when used in line illumination, the fluorescent lamps can be arranged with narrower gaps therebetween. Also, when the fluorescent lamps are arranged in series in their longitudinal direction, dark parts between the fluorescent lamps can be diminished.

In the above-described lighting apparatus, more than one of the fluorescent lamps may be arranged in a longitudinal direction thereof.

Additionally, in order to achieve the stated aim, the manufacturing method of the fluorescent lamp pertaining to the present invention is a manufacturing method of a fluorescent lamp, the manufacturing method comprising a welding process of welding a plate-shaped stem having an electrode to an end wall of a tubular bulb so as to externally block an opening provided at a center of the end wall, wherein the welding process includes a process of pushing the stem into the bulb when (a) a contact portion where the end wall and the stem overlap and are in contact with each other and (b) a portion, of the end wall, surrounding the contact portion become deformable as result of being heated.

The stated method facilitates manufacturing of a fluorescent lamp which achieves a smaller outward protrusion amount of the bases from the imaginary planes respectively containing edges of the bulb.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is a schematic longitudinal sectional view of a structure of an end portion of a lamp under study;

FIG. 2 is a perspective view of a structure of a lamp pertaining to an embodiment of the present invention, with an end portion of the lamp shown in an enlarged scale;

FIG. 3 is a schematic longitudinal sectional view of a structure of the end portion of the lamp;

FIG. 4 shows the lamp when viewed in a Y-direction in FIG. 2;

FIG. 5 shows a lighting apparatus including the lamp;

FIGS. 6A-6C are process drawings each showing a manufacturing process of the lamp;

FIGS. 7A-7C are process drawings each showing a manufacturing process of the lamp; and

FIG. 8 is a longitudinal sectional view of an end portion of a lamp pertaining to a modification.

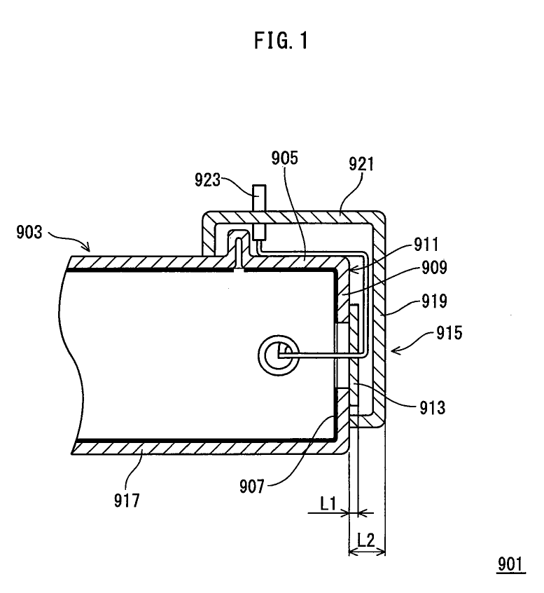

### DESCRIPTION OF THE PREFERRED EMBODIMENT

The following describes the best mode for carrying out the invention using an embodiment with reference to drawings. Note that the embodiment in the following description is only an example used to provide a clear explanation on a structure of the present invention and effects and advantages obtained therefrom, and the present invention is not limited to this except for its characterizing features.

### Embodiment

The following describes a structure of a fluorescent lamp (hereinafter, referred to simply as “lamp”) and a lighting apparatus pertaining to the present embodiment, with reference to the drawings.

### 1. Structure of Lamp

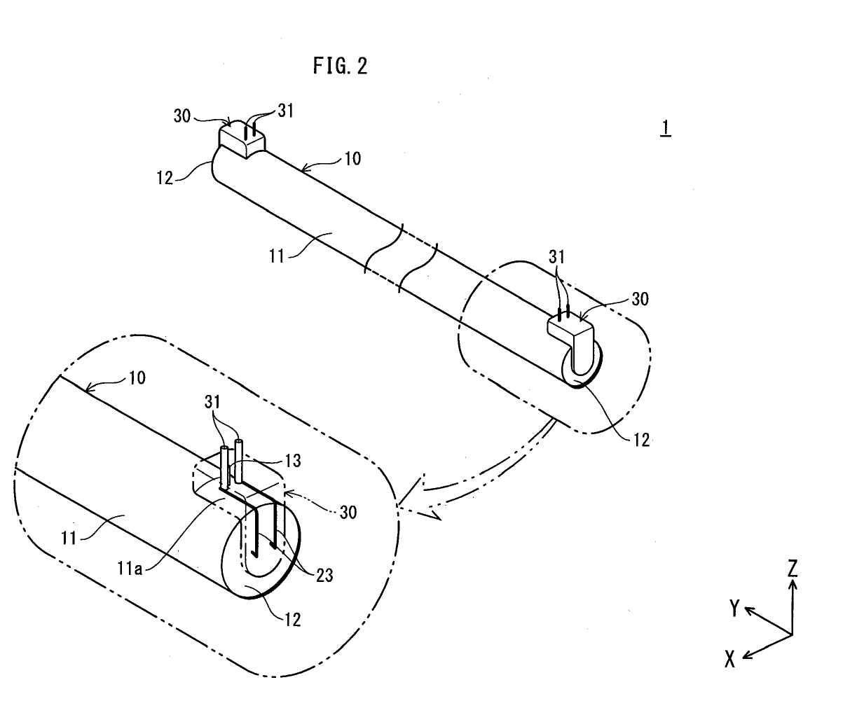

FIG. 2 is a perspective view of the structure of a lamp 1 pertaining to the present embodiment, with an end portion of the lamp 1 shown in an enlarged scale.

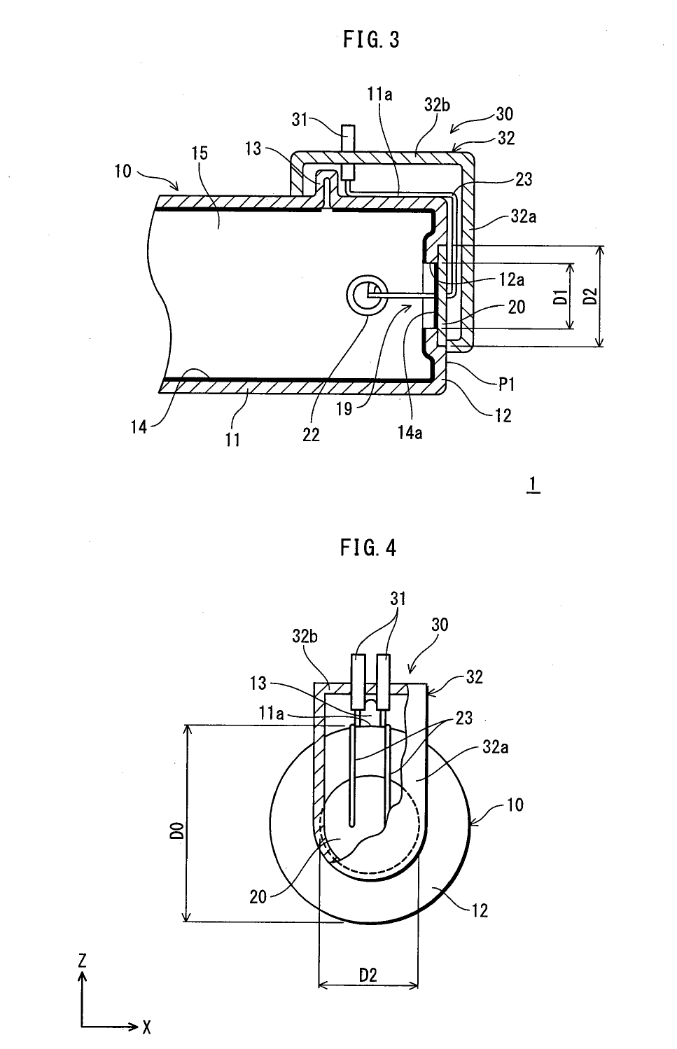

FIG. 3 is a schematic longitudinal sectional view of the structure of the end portion of the lamp 1, and FIG. 4 shows the lamp 1 when viewed in a Y-direction in FIG. 2.

As shown in FIGS. 2 and 3, the lamp 1 includes a bulb 10 and bases 30. The bulb 10 is in an elongated cylindrical shape and has a stem mount 19 including an electrode 22, at its respective ends in its tube axis direction (bulb axis direction; the Y-direction in the figure). The bases 30 are electrically connected with the respective electrodes 22 and attached to respective end portions of the bulb 10. Note that the bulb is, in other words, an arc tube.

(1) Bulb

The bulb 10 includes a glass tube, a fluorescent layer 14 (see FIG. 3) formed on the inner surface of the glass tube, and the stem mounts 19 respectively attached to end portions of the glass tube. More specifically, as shown in FIG. 2, the bulb 10 includes a cylindrical portion 11 of the glass tube in a cylindrical shape, end walls 12 at ends of the cylindrical portion 11, a thin tube 13 for exhaust and such provided on the outer circumferential surface of one of the end portions of the cylindrical portion 11, and the stem mounts 19 respectively attached to the end walls 12. The following should be noted here: an opening 12a exists at the substantial center of each end wall 12 of the glass tube (see FIG. 3), and each stem mount 19 is attached to an surrounding portion of the corresponding one of the openings 12a of the end walls of the glass tube so as to close the opening 12a; when the bulb 10 is completed by enclosing mercury or the like therein, as will be described later, the cylindrical portion 11 of the glass tube becomes the cylindrical portion of the bulb, and likewise, the end walls 12 of the glass tube become the end walls of the bulb.

As the fluorescent layer 14, an ordinary three band fluorescent is used.

The bulb 10 is hermetically sealed as a result of the openings 12a at the center of the end walls 12 of the glass tube being blocked by stems 20 (described later). Inside the bulb 10, mercury (Hg) as a discharge material, and argon (Ar) gas or the like as a rare gas are enclosed via the thin tube 13 (not illustrated). After enclosing such predetermined gases and the like, the thin tube 13 is tipped off (sealed) using a known technique, and the interior of the bulb becomes a discharge space 15.

Note that the bulb is structured (completed) as a result of the formation of the discharge space 15 within the bulb.

The thin tube 13 is positioned closer to the center of the cylindrical portion 11 in its axis direction than the corresponding electrode (filament coil 22) provided in the discharge space 15 is. In other words, the distance between the thin tube 13 and the edge (circumferential edge of the end portion) of the bulb 10 is longer than the distance between the electrode 22 (coil axis of the filament coil) and the edge (circumferential edge of the end portion) of the bulb 10.

(2) Stem Mount

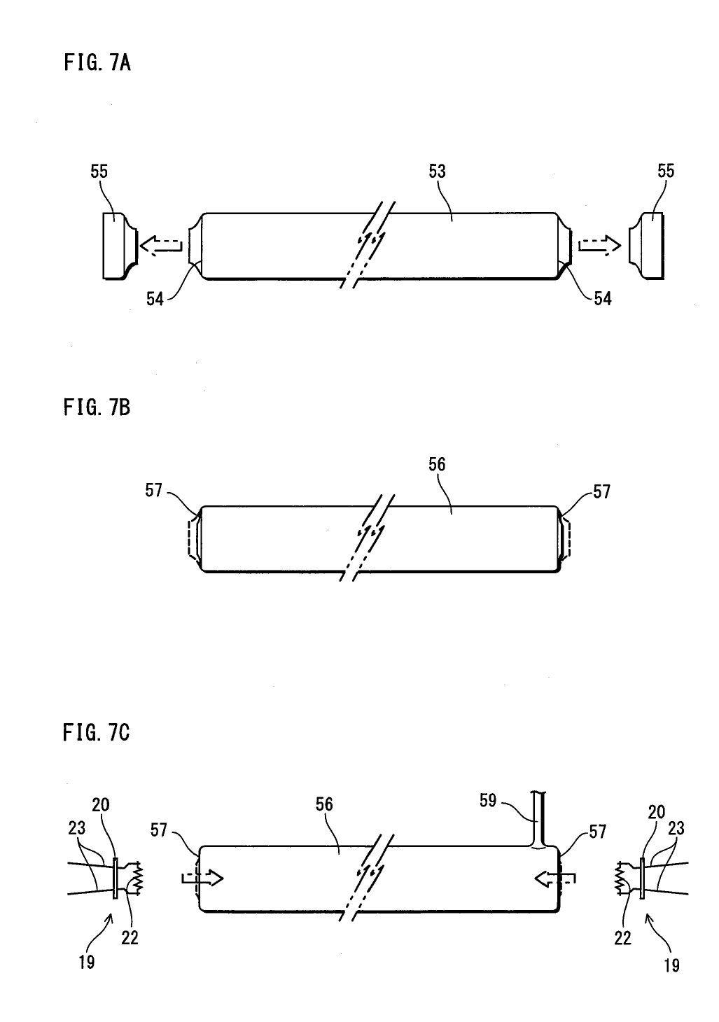

As shown in FIGS. 3 and 7C, each stem mount 19 is composed of a stem 20, a pair of leads 23 penetrating the stem 20, and one of the electrodes 22 which is supported by the pair of leads 23.

Each electrode 22 is composed of a filament coil in a coil form and suspended between the pair of leads 23, the ends of the filament coil being supported by one ends of the pair of leads 23.

Each stem 20 is a so-called button stem (hereinafter, “button stem” is used as “stem”) 20 that is made of glass and is disk-shaped. The electrode 22 is fixed to the button stem 20 in a state where the pair of leads 23 and the button stem 20 are closely attached with each other (airtight) with the pair of leads 23 inserted into the button stem 20 in its thickness direction. Note that the electrodes 22 are of a so-called hot-cathode type and have a coiled portion made of at least one turn.

As shown in FIG. 3, the opening of each end wall 12 is circular in shape. An outer diameter D2 of the button stem 20 is greater than a diameter D1 of the opening 12a of the end wall 12, and the button stem 20 is welded to the end wall 12 in a manner that part of the surface, which faces the filament coil (hereinafter, referred to as “inner surface”), of the button stem 20 and the part of the end wall 12 surrounding the opening 12a (surrounding portion) overlap with each other.

Here, with the stem welded to the glass tube, the end surface of the bulb 10 is composed of the outer surface of the button stem 20 and part of the end wall of the glass tube, the part surrounding the welded button stem 20 (that is, of the end wall, the part which does not overlap with the button stem).

In other words, the end surface of the bulb 10 is what is visible of the bulb 10 when the bulb 10 is viewed in its tube axis direction, and the end wall 12 of the bulb 10 is composed of the portion overlapping with the button stem 20 and the portion around the button stem 20 (this portion constitutes the end surface of the bulb 10). Note that the end wall 12 and the button stem 20 are welded together where they overlap with each other, forming a circular welded portion.

Here, in the end surface of the bulb 10, for example, the portion, of the end wall of the glass tube, welded with the button stem 20, and the portion surrounding the welded portion are recessed toward the inside of the bulb 10, and the inner surface of the button stem 20 is positioned further inside of the bulb 10 compared with the imaginary plane containing the corresponding edge of the bulb 10 (the imaginary plane being “P1” in the figure and equivalent to the end surface of the bulb 10). In other words, the end wall 12 of the glass tube and the opening 12a thereof are recessed, the button stem 20 exists in the recessed part of the end wall 12 (surrounding portion of the opening 12a), and the outer surface of the button stem 20 is substantially flush with the imaginary plane P1 containing the outer edge of the end portion of the bulb 10.

Here, description is given using a specific example. It is assumed that an outer diameter D0 of the bulb 10 (glass tube) is 25.5 (mm), the diameter of the opening D1 of the end wall 12 is 9.8 (mm), and the outer diameter D2 of the button stem 20 is 12.5 (mm).

In order to secure the luminous flux of the lamp 1, the fluorescent layer 14a is formed not only on the inner surface of the bulb 10 (inner surface of the glass tube), but also formed on the surface of the button stem 20, which faces the discharge space 15 and positionally corresponds with the opening 12a (i.e. the portion exposed to the discharge space).

As shown in the enlarged view in FIG. 2, the pair of leads 23 extend from the end surface of the bulb 10 (to be precise, the outer surface of the stem) and are electrically connected with the base pins 31 of the base 30. As shown in the enlarged view in FIG. 2, the pair of leads 23 are bent immediately after leading out from the button stem 20, arranged along the outer surface of the button stem 20, the end wall 12 of the bulb 10, and the circumferential wall 11a that is part of the cylindrical portion 11 and a portion close to the end wall 12, and covered by the base 30.

(3) Base

Each base 30 includes a base main body 32 and the base pins 31. The base main body 32 is fixed to one of the end portions of the bulb 10 using a bonding agent (for example, a silicone resin), and the base pins 31 are provided on the base main body 32 and connected with the leads 23 that support the electrode 22. Note that although the interior of the base 30 is filled with the bonding agent, an illustration is omitted to give a clear view of wiring of the leads, end surface, and the like.

As shown in FIGS. 2 and 4, the base 30 is provided to cover the button stem 20 and is provided in a manner that the end wall 12, of the bulb 10, other than the button stem 20 is exposed. Here, “exposed” means that the appearance of the end wall 12 is visible when the base is made of a translucent material. Further, in other words, the part of the end wall which constitutes the end surface is not covered by the base 30.

As shown in FIGS. 2-4, the base main body 32 is L-shaped, following the shape of the end portion of the bulb 10, and includes a first base portion 32a and a second base portion 32b. The first base portion 32a covers the end wall 12 of the bulb 10, and the second base portion 32b covers the cylindrical portion 11 of the end portion of the bulb 10. With this structure, a larger bonding area can be attained between the base 30 and the bulb 10, allowing the base 30 to be firmly fixed to the bulb 10.

The base main body 32, that is, the first base portion 32a and the second base portion 32b, are hollow inside and are open at their ends fixed to the bulb 10. Accordingly, fixed to the end part of the bulb 10, the base 30 stores therein the leads 23, which lead out from the button stem 20 and are arranged along the end wall 12 of the bulb 10 and the circumferential wall of the cylindrical portion 11.

As described above, the fluorescent layer 14a is formed on the inner surface of each button stem 20, and it is preferable that the base main body 32 be made of a translucent material (for example, PBT or PC) so as to extract as much light converted by the fluorescent layer 14a as possible out of the bulb 10.

As shown in FIGS. 2-4, the base pins 31 are vertically positioned extending in the direction perpendicular to the tube axis of the bulb 10 (Z-direction in FIG. 2), and have the leads 23 inserted therein, respectively. That is to say, according to the lamp 1 of the present embodiment, the base pins 31 do not extend outwardly from the end surface of the bulb 10 in its tube axis direction, but instead, are vertically arranged extending outwardly from the cylindrical portion 11 (circumferential wall 11a) of the bulb 10 in the direction perpendicular to the tube axis. Note that the base, leads, and the like which are not shown in the enlarged view have the same structure (illustration omitted).

In the lamp 1 with the above-described structure, each base 30 is fixed to the bulb 10 with its base pins 31 arranged on the cylindrical portion 11 of the bulb 10 and the pair of leads 23 leading out from the button stem 20 arranged along the outer surface of the bulb 10 that includes the button stem 20. As a result, the base 30 protrudes less from the end portion of the bulb 10.

Furthermore, the end wall 12 of the glass tube, to which the button stem 20 is fixed, especially the end wall portion that overlaps with the button stem 20, is depressed inward toward the other end, i.e., is recessed. This enables the outer surface of the button stem 20 to be flush with the end of the cylindrical portion 11, eliminating the protrusion from the end portion of the bulb 10.

As is apparent from the above, according to the lamp 1 of the present embodiment, in terms of the size of the bulb 10 in its axis direction, the space between the imaginary plane P1 containing the outer edge of the end portion of the bulb 10 and the inner surface of the bulb 10 needs to be only large enough to store the leads 23. As a result, the thickness of the portion of the base 30 covering the end wall 12 of the bulb 10 can be reduced, and a novel design is provided.

### 2. Lighting Apparatus

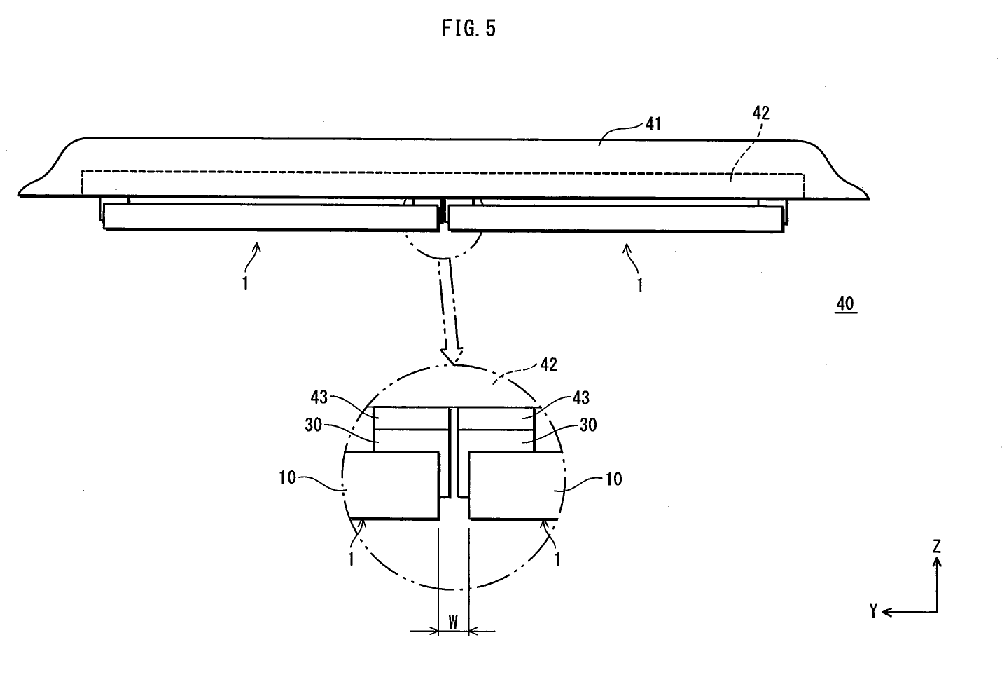

The following describes a lighting apparatus having the lamp 1 pertaining to the present embodiment as a structural component, with reference to FIG. 5.

FIG. 5 shows the lighting apparatus provided with the lamp 1 and a portion between two adjacent lamps in an enlarged scale.

As shown in FIG. 5, a lighting apparatus 40 has, as an example, two lamps 1, and the lamps 1 are arranged in series. In the lighting apparatus 40, four sockets 43 are provided on an apparatus main body 42, to each of which the base pins 31 of the lamps 1 are inserted. Accordingly, the four sockets 43 are arranged in series in the Y-axis direction.

Also, according to the lighting apparatus 40 of the present embodiment, with the base pins 31 of the two lamps 1 respectively inserted to the sockets 43 of the apparatus main body 42, the two lamps 1 are arranged in series. In this case, as the encircled part in FIG. 5 shows, because the thickness of the bases 30 in terms of the size in the tube axis direction of the lamps 1 is smaller, a gap W between the two lamps 1 in the longitudinal direction (the Y-axis direction) can be shortened compared to conventional lamps which have bases at their ends in their longitudinal direction (to be described in “3. Superiority of Lamp 1 and Lighting Apparatus”).

It should be noted that in the present embodiment, although the apparatus main body 42 is embedded in a ceiling 41, it can be fixed to the ceiling instead.

### 3. Superiority of Lamp 1 and Lighting Apparatus

As shown in FIG. 3, the lamp 1 of the present embodiment has a structure where the surrounding portion of the opening 12a of the end wall 12 of the bulb 10 is recessed toward the discharge space 15 (recessed in the tube axis direction of the bulb 10 toward its center) and the button stem 20 is welded to the recessed portion. This structure allows for a decrease in the outward protrusion of the end surface (including the end wall 12 and the button stem 20) of the bulb 10 in its tube axis direction.

Accordingly, each base 30 fixed to the end portion of the bulb 10 requires only a space large enough to store the pair of leads 23 therein, and consequently, of the base 30, the thickness of the portion fixed to the end surface of the bulb 10 can be made thinner. As a result, when the lamps 1 are used for line illumination as shown in FIG. 5, a gap between two lamps (“W” in the figure) becomes shorter, enabling the lamps to illuminate as if they were a single lamp.

Additionally, the bases 30 made of a translucent material do not block the light emitted from the bulb 10, increasing the light radiated toward the outside. This results in an increase in a light amount passing through between two adjacent lamps 1 used in line illumination and consequently a reduction in difference between the brightness of an intermediary portion of the lamp 1 in its tube axis direction and the brightness of the adjacent lamp 1. This further enhances the multiple lamps to illuminate as if as a single lamp.

### 4. Manufacturing Method of Lamp

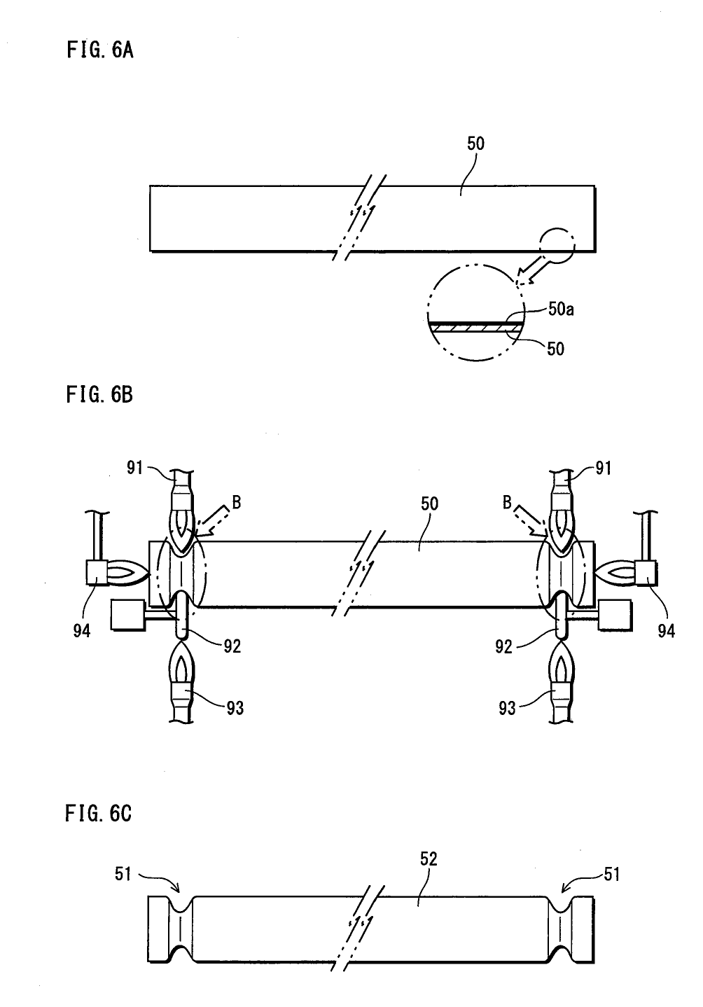

The following describes a manufacturing method of the lamp 1 according to the present embodiment, with reference to FIGS. 6A-6C and 7A-7C. It should be noted that in the following, only characteristic aspects of the manufacturing method of the lamp 1 are described, and processes similar to manufacturing methods of lamps according to prior arts are omitted.

As shown in FIG. 6A, a tubular body 50 in a cylindrical shape is prepared. A fluorescent layer 50a is formed on the inner surface of the tubular body 50. The fluorescent layer 50a is made from the fluorescent materials (Y₂O₃: Eu³⁺, LaPO₄: Ce, Tb, BaMgAl₁₀O₁₇:Eu, Mn).

Next, as shown in FIG. 6B, the diameter of the tubular body 50 is reduced at its end portions (indicated by arrows B) using molding rollers 92 while the tubular body 50 is rotated with its tube axis as the rotating axis and with its end portions being heated with heating burners 91. The penetration amount of the molding rollers 92 is determined based on the reduced diameter of the tubular body 50 and the diameter of the openings 12a of the scheduled glass tube. It should be noted that because the openings 12a are to be blocked by the button stems 20 (openings scheduled to be stem-blocked), the diameter of the openings 12a is determined also by the diameter of the button stems 20.

Note that the molding rollers 92 are heated by roller heating burners 93 to reduce a temperature difference between the temperature of the portions of the tubular body 50 heated by the heating burners 91 and the molding rollers 92. Also, the openings of the tubular body 50 are heated by glazing burners 94, respectively.

As shown in FIG. 6C, the diameter is reduced to a predetermined diameter to form a tubular body 52 having a diameter-reduced portion 51 in vicinity of each end portion thereof.

Next, the tubular body 52 is cut at the bottom of the diameter-reduced portions 51. As a result, as shown in FIG. 7A, the tubular body 52 is divided into end portions 54 each having an opening, a main body portion 53 having the end portions 54, and cut-end portions 55 resulting from the cuts. Note that as a method for cutting the end portions, an abrasive cut using a grinding stone, a chill cut using a burner with a sharp flame or the like can be used.

In a process shown in FIG. 7A, because the end portions 54 still possess heat applied during the cuts, the diameter of the openings is reduced over time due to surface tension (see FIG. 7B). As shown in FIG. 7B, over a course of time, a tubular body 56 having at each end wall 57 an opening whose diameter is smaller than the diameter of the bulb (see 12a in FIG. 3) is formed.

As shown in FIG. 7B, at the end of this process, each end wall 57 of the tubular body 56 protrudes outwardly in the tube axis direction of the tubular body 56.

As shown in FIG. 7C, the stem mount 19 is attached to each end portion of the tubular body 56. Specifically, this is performed by blocking each opening (12a) of the tubular body 56 using the button stem 20 and welding the circumferential edge of the button stem 20 to the portion surrounding the opening (12a). Note that prior to the sealing using the button stems 20, a thin tube 59 for exhausting is connected to the tubular body 56.

In a process of attaching the thin tube 59, the tubular body 56 is perforated by heating with a burner at a position where the thin tube is scheduled to be attached (“blow and break”), and the thin tube 59 with a heated tip is pushed therein.

Here, if the fluorescent layer 50a is formed on the inner surface of the tubular body 56, the thin tube 59 can be directly attached to the tubular body 56, or alternatively, the thin tube 59 can be attached to the tubular body 56 after removing the fluorescent layer 50a from where the thin tube 59 is to be attached. Directly attaching the thin tube 59 to the tubular body 56 improves an efficiency of the attaching process of the thin tube 59. Attaching the thin tube 59 to the tubular body 56 after removing the fluorescent layer 50a from where the thin tube 59 is to be attached improves a reliability of the attachment since a fluorescent material is unlikely to be contained at the attached position.

In a process of welding the stem mounts 19, each button stem 20 to which the electrode (filament coil) is attached is brought into contact with the end wall 57 (outer surface thereof) of the tubular body 56 from the outside of the tubular body 56. Here, each electrode is inserted to the interior of the tubular body 56 through the opening positioned at the end wall 57 of the tubular body 56.

Next, portions where the end walls 57 of the tubular body 56 and the button stems 20 are in contact with each other, and the end walls 57 around these portions are heated, for example, by a burner, and when the glass is heated to a deformable state, the button stems 20 are pushed toward the interior of the tubular body 56. As a result, the end walls 57 and the button stems 20 are welded together. It should be noted that the button stems 20 are pushed until, for example, the outer surface of the button stems 20 are substantially flush with the edges of the tubular body 56, respectively.

Finally, upon the stem mounts 19 being welded to the tubular body 56, the interior of the tubular body 56 is vacuumed (exhausting air and the like inside the tubular body 56), mercury, a rare gas, and the like are enclosed in the tubular body 56 using the thin tube 59, and the thin tube 59 is sealed (by way of “tip-off method”). As a result, a bulb having therein a discharge space is manufactured, and fixing bases to end portions of the bulb completes the lamp.

### 5. Others

### (1) Lamp

According to the embodiment above, the lamp 1 in a straight shape is used as an example. However, the present invention can be applied to lamps in a circular shape. Applying the present invention to lamps in a circular shape allows for a narrower gap between one end of the tube and the other end, and consequently, provides lamps with a novel design. Furthermore, a smaller non-light emitting area can be achieved at where the ends of the tube come close to each other, thereby enabling the lamp to illuminate as if it were a seamless circle.

### (2) Fluorescent Materials

According to the embodiment, the above-mentioned fluorescent materials are used as constituent materials of the fluorescent layer 14. However, the present invention is not limited to these, and the constituent materials can be appropriately changed to fluorescent materials that are commonly used in formation of lamps.

### (3) Position of Stem

According to the embodiment, when one of the end portions of the bulb 10 is viewed in the direction perpendicular to the tube axis of the bulb 10 (i.e. FIG. 3), the outer surface of the button stem and the imaginary plane P1 defined by the outer edge of the end portion substantially coincide with each other (are substantially flush with each other). However, the outer surface of the button stem can be positioned further toward the interior of the bulb (toward the other end portion) than the imaginary plane P1 is. In the following, this case is described as a modification.

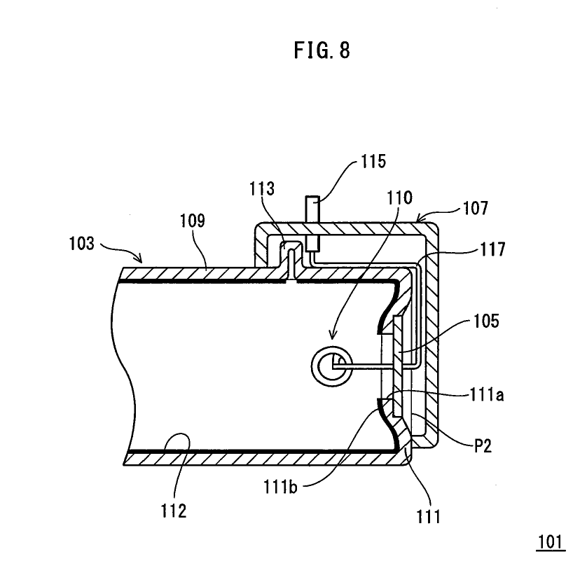

FIG. 8 is an enlarged view of a lamp end portion pertaining to the modification.

As is the case with the embodiment, a lamp 101 includes a bulb 103, button stems 105 each having an electrode, and bases 107. Each base 107 is fixed to an end portion of the bulb 103 using a bonding agent and has base pins 115 to which leads 117 extending from the button stem 105 are connected. Note that although the interior of each base 107 is filled with the bonding agent, an illustration is omitted to give a clear view of wiring of the leads, end surface, and the like.

The bulb 103 includes a glass tube, a fluorescent layer 112 formed on the inner surface of the glass tube, stem mounts 110 attached to end portions of the glass tube, and a thin tube 113.

The glass tube includes a cylindrical part 109 and end walls 111 at both ends of the glass tube, with an opening 111a provided at the center of each end wall 111.

Here, also, upon completion of the bulb 103 by attaching the button stems 105 of the mount stems to the glass tube and enclosing mercury and the like (to be described later) in the glass tube, the cylindrical portion 109 of the glass tube becomes the cylindrical portion of the bulb, and similarly, the end walls 111 of the glass tube become the end walls of the bulb.

Each button stem 105 is welded to one of the end walls 111 in a state where part of the inner surface of the button stem 105 overlapping with a surrounding portion of the opening 111a of the end wall 111.

Here, with the stems welded to the glass tube, each end surface of the bulb 103 is composed of the outer surface of one of the button stems 105 and part of one of the end walls of the glass tube, the part surrounding the welded button stem 105 (that is, the part of the end wall which does not overlap with the button stem).

In each end surface of the bulb 103, for example, the end wall of the glass tube is recessed in a manner that it extends from the outer edge of the end portion of the bulb toward the outer edge of the button stem 105, and the outer surface of the button stem 105 is positioned further inside with respect to the bulb 103 than an imaginary plane (“P2” in the figure) containing the outer edge of the end portion of the bulb 103 is.

As described above, because the end wall 111 of the bulb 103, to which the button stem 105 is attached, is recessed, the outer surface of the button stem 105 is positioned further inside in the bulb 103 than the imaginary plane P2 containing the outer edge of the end portion of the bulb 103 is. As a result, the protrusion of each base 107 from the end portion of the bulb 103 is eliminated.

Here, if the amount of protrusion of each button stem 105 at the end surface of the bulb 103 is reduced as described above, the amount of the protrusion of the base 107 becomes smaller accordingly. However, for example, as in the embodiment, if the outer surface of the button stem 20 is substantially flush with the imaginary plane P1 containing the outer edge of the end portion of the bulb 10, the bonding strength between the bulb 10 and the base 30 will drop.

That is to say, if the outer surface of the button stem 20 is substantially flush with the imaginary plane P1 containing the outer edge of the end portion of the bulb 10, the bonding agent which bonds the end surface of the bulb 10 and the base 30 cannot hang on the end surface of the bulb 10. This results in a decrease of the bonding area between the bulb 10 and the base 30, leading to a decline in the bonding strength.

On the other hand, if the outer surface of the button stem is positioned outside the imaginary plane containing the outer edge of the end portion of the bulb, although the protrusion amount of the base becomes larger, the bonding agent, which bonds the end surface of the bulb and the base, can hang on a step formed between the circumferential edge of the button stem, which is part of the end surface of the bulb, and the end wall of the glass tube. This results in an increase in the bonding area between the bulb and the base, thereby improving the bonding strength.

According to the lamp 101 of the present modification, the outer surface of the button stem 105 is positioned further into the bulb 103 than the imaginary plane P2 containing the outer edge of the end portion of the bulb 103 is. Consequently, the protrusion amount of the base can be reduced while at the same time also improving the bonding strength between the bulb 101 and the base 107.

In other words, because the bonding agent bonding the end surface of the bulb 103 and the base 107 can go into the recessed part where the outer surface of the button stem 105 is positioned further inside than the imaginary plane P2 containing the outer edge of the end portion of the bulb 103, the bonding agent can hang on the end surface of the bulb 103. This increases the bonding area, improving the bonding strength as a result.

As described above, in the lamp 101 of the modification, the protrusions of the end surfaces of the bulb 103 are eliminated. Accordingly, there is no place where the bulb 103 and the bases 107 can hang on each other. Nonetheless, because the bonding agent 119 goes into the recessed portions of the end surfaces, a sufficient bonding strength can be obtained. Thus, with a reduction in the protrusion amount of the bases 107, lamp illumination with smaller dark parts between the lamps 101 can be realized.

### (4) Size of Stem

The embodiment above does not provide a specific description on a relationship between the openings provided on the end walls of the bulb (before welding the stems) and the size of the stems. However, it is preferable that the size of the stems be in a range of 1.2 to 1.5 times the size of the openings. If the size of the stems is smaller than 1.2 times the size of the openings, the stems, when welded, are likely to contract to a size smaller than the size of the openings due to melting. On the other hand, if the size of the stems is larger than 1.5 times the size of the openings, the stems are unnecessarily large, causing an increase in cost.

It should be noted that while the relationship between the diameter of the stems and the size of the openings are specified in terms of ratio with respect to the size of the openings, each overlapping portion of the stem and the end wall is preferably in a range of 1 (mm) to 2.5 (mm) inclusive.

### (5) Thickness of Stem

The embodiment above does not provide a specific description on a relationship between the thickness of the end walls of the bulb (before welding the stems) and the thickness of the stems. However, it is preferable that the thickness of the stems be in a range of 0.8 to 3.0 times the thickness of the openings (thickness of the end walls of the glass tube). When the thickness of the stems are in this range, the stems and the end walls melt substantially concurrently during the welding, improving the thermal and mechanical strength of the welded portions as a result.

Specifically, if the thickness of the stems is smaller than 0.8 times the thickness of the end walls, the stems melt faster than the end walls, resulting in the size of the stems being smaller than that of the openings of the end walls. On the other hand, if the thickness of the stems is larger than 3.0 times the thickness of the end walls, the end walls melt faster than the stems, resulting in the size of the openings being larger than that of the stems.

Note that if the thickness of the stems is less than 1 (mm), leakage occurs where the lead wires are inserted into the stems. Thus, it is preferable that the thickness of the stems be not smaller than 1 (mm) and not larger than 3.0 times the thickness of the openings (thickness of the end walls of the glass tube).

Additionally, if the thickness of the end walls of the bulb and the thickness of the stems constitute the above-mentioned ratio after the welding, the thermal and mechanical strength of the welded portions are improved, and the leakage that occurs where the lead wires are inserted into the stem is reduced.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. A fluorescent lamp, comprising:
a bulb including (a) a circumferential wall whose inner surface is coated with a fluorescent layer and (b) end walls each partially composed of a stem to which an electrode is attached, the stem being plate-shaped; and
bases each provided covering a corresponding one of the stems such that at least part of each end wall other than the stem is exposed, wherein
an inner surface of each stem is positioned closer to a center of the bulb in a bulb axis direction than an imaginary plane containing a corresponding edge of the bulb is.

2. The fluorescent lamp of claim 1, wherein
an outer surface of each stem is positioned closer to the center of the bulb than the imaginary plane is, and
each end wall other than a portion composed of the stem extends from the corresponding edge of the bulb toward an edge of the stem.

3. The fluorescent lamp of claim 1, wherein
an outer surface of each stem is substantially flush with the imaginary plane.

4. The fluorescent lamp of claim 1, wherein
each stem is disk-shaped and blocks an opening provided at a center of the end wall, and an outer diameter of the stem is in a range of 1.2 times to 1.5 times an outer diameter of the opening.

5. The fluorescent lamp of claim 1, wherein
a thickness of each stem is in a range of 0.8 times to 3 times a thickness of each end wall other than a portion composed of the stem.

6. A lighting apparatus, comprising:
an apparatus main body; and
one or more fluorescent lamps attached to the apparatus main body, wherein
each of the fluorescent lamps is the fluorescent lamp of claim 1.

7. The lighting apparatus of claim 6, wherein
more than one of the fluorescent lamps is arranged in a longitudinal direction thereof.

8. A manufacturing method of a fluorescent lamp, the manufacturing method comprising a welding process of welding a plate-shaped stem having an electrode to an end wall of a tubular bulb so as to externally block an opening provided at a center of the end wall, wherein
the welding process includes a process of pushing the stem into the bulb when (a) a contact portion where the end wall and the stem overlap and are in contact with each other and (b) a portion, of the end wall, surrounding the contact portion become deformable as result of being heated.
